(19) United States
(12) Patent Application Publication
(10) Pub. No.: US 2016/0076164 A1
(43) Pub. Date: Mar. 17, 2016

(54) MOLD CAVITY WITH IMPROVED WEAR RESISTANCE AND METHOD OF MANUFACTURE THEREOF

(71) Applicant: Pfaff Molds LP, Charlotte, NC (US)

(72) Inventor: Troy DeVlieger, Sherrils Ford, NC (US)

(21) Appl. No.: 14/851,374

(22) Filed: Sep. 11, 2015

Related U.S. Application Data
(60) Provisional application No. 62/049,176, filed on Sep. 11, 2014.

(51) Int. Cl. C25D 13/02; C25D 13/20; B29C 33/38

(52) U.S. Cl. CPC C25D 13/02; B29C 33/3842; C25D 13/20; B29K 2905/12; B29K 2909/04

(57) ABSTRACT

A method and system for forming a mold cavity is provided. The method and system contemplate a process of discharging a hardening element or material into a first material and subsequently machining the infused product to a desired shape such as a tear bead shape for a mold cavity for forming rubber and metal components. The methods and systems provided herein contemplate selective hardening of specific portions or features of a mold cavity without the need to provide conventional cooling or quenching operations.

This U.S. Non-Provisional Patent Application claims the benefit of priority from U.S. Provisional Patent Application Ser. No. 62/049,176, filed Sep. 11, 2014, the entire disclosure of which is hereby incorporated by reference.

### BACKGROUND OF THE INVENTION

Rubber (including ethylene propylene diene terpolymer or “EPDM”) injection molds typically feature grooves along a perimeter of a mold cavity, the mold cavity comprising the cavity in which a part is formed. The grooves generally have two functions. First, grooves allow trapped air to escape the cavity and thereby allow for the molded part to fully conform to and take the shape of the cavity. Grooves further allow for excess injection material to spill or overflow out of the mold area. After a molded part is formed, an operator may remove excess or spilled material from the molded part by tearing the excess material along groove or bead. Accordingly, such a groove feature is often referred to as a “tear bead”. A landing or gap space between a groove and the mold cavity is typically very small and less than approximately 1 mm or 0.04 inches.

Typical mold steels have a Rockwell hardness of 28 to 45 HRC. During maintenance work or when the mold is cleaned, a landing area of the mold is known to erode. This results in a. growingly thicker tear bead over the life of the mold. The thicker tear bead creates complications, including making tearing or excess-removal operations difficult without damaging the molded part. In short, an eroded landing reduces the efficacy of the tear bead. Once a tear bead is sufficiently worn, the tear bead is typically scissor trimmed, or the mold is welded and re-machined. These options are time consuming, expensive, and undesirable.

It is known to harden an entire mold or to apply hard surface coatings. Such options suffer from the drawback of being significantly expensive, and result in reduced performance in processing and working with the mold. Spot-welding on hardened surfaces is not feasible for making minor adjustments to the mold, as any surface coatings will eventually wear off and require replacement.

Methods of transfer molding are well known in the art. Transfer molding is used extensively in both the plastics and rubber industries. A rubber transfer process is comprised of a “hot” or “cold” (temperature controlled) transfer pot system, which is frequently referred to as the “transfer pot”, and a mold having a mold cavity for forming the desired part. A typical “cold” transfer pot system is comprised of a chamber for holding material to be molded, a piston that drives the material into a mold, and an insulator board. A transfer mold can be run in a compression press machine, where the material is manually put into the pot or in an injection press where the material is automatically injected into the pot. Waste-less molding is the art in which a “cold” transfer pot system is used to create a temperature gradient differential between the transfer pot and the mold. This technique allows the material to cure or vulcanize up to a particular depth into the transfer pot, thus minimizing waste and allowing material to be used for the repeated molding cycle(s).

The mold cavity is immediately adjacent to the insulator board. Running through the insulator board and into mold cavity of the mold is an injection port. Material is forced by the transfer pot, through the injection port in the insulator board and into the mold cavity to form the desired part. During the molding process, using a waste-less technique, waste material is only formed in the injection ports of the mold and insulator board. These pieces of waste material are called sprues, mold sprues or molded sprues. The waste material frequently can weigh more than the desired molded part when not using a waste-less technique, and because rubber undergoes a chemical reaction called vulcanization in order to set and form the desired part, waste produced in the molding process can not be recycled as it is with plastics. In the auto industry and other specialty industries, where designer rubber compounds are often used for specialized applications the amount of the waste product often exceeds the actual part and thus makes the parts quite expensive. Also, the environmental effect of disposing waste material is significantly reduced. Accordingly, there is still a need for a method of molding rubber that further minimizes the amount of waste material produced in molding a desired rubber part.

Because many rubber molding applications can be automated, it is desirable that the mold sprues be easily separable from the molded parts. Current methods have used a unified sprue, typically called a cull pad, wherein the sprues of the multiple molded parts are interconnected with gates to allow automatic equipment or people to easily separate the sprue from the parts. This technique, however, suffers from a disadvantage in that it produces too much waste material (additional gates) that cannot be recycled. Another current technique involves using a piece of porous cloth between the insulator board and the sprue. During the transfer of the rubber into the mold cavity, the rubber passes through the porous cloth. As the rubber sets, however, it fuses to the cloth. The sprues can then be easily separated from the mold by peeling the piece of cloth away from the mold. This technique, however, suffers from the disadvantage that the part formed by this process frequently has fibers from the cloth embedded in it, making the part, at best, undesirable and at worst, unusable. Also, the cloth can not be re-used, increasing the cost of producing a part. Therefore, there is a need for a method to easily separate the sprues from the molds of mass produced rubber parts.

Another problem that must be overcome in molding rubber is minimizing the mess caused by un-vulcanized rubber that leaks from a transfer pot or that is drawn out by the vulcanized rubber in the sprue. If the sprues from molded parts are not removed with care, un-vulcanized rubber clinging to the end of the vulcanized rubber end of the sprue may be transferred to the outside portion of the mold, the mold and transfer pot matting surfaces, or onto another undesirable surface that could interfere with the production of the molded parts. These unwanted deposits can enhance the effects of mold fouling. Therefore there is a need for a method to remove the vulcanized rubber sprues from a mold that minimizes the opportunity for the inadvertent transfer of un-vulcanized rubber onto other surfaces.

### SUMMARY OF THE INVENTION

Accordingly, there has been a long-felt and unmet need to provide a mold with a tear bead of enhanced hardness and/or durability, while still providing a mold that is economical to manufacture and replace. Accordingly, embodiments of the present invention contemplate combining existing hardening and coating applications in a specific sequence. Various embodiments of the present invention provide an extremely wear resistant surface that significantly extends service and maintenance intervals, in some cases by more than 50%. Although various molding operations and methods are referenced herein, it will be expressly recognized that the present invention is not limited to any particular type of molding operation. For example, methods and systems of the present invention have been shown to be particularly well suited for rubber injection molds, but may be applied and utilized in various different or similar applications.

As used herein, the terms “electro-hardening” and “electro metal surface hardening” generally refer to the processes of impregnating wear resistance or resistive metals via metal probes to the exterior and interior parts of a device or surface. In certain embodiments, the present invention provides electro-hardening surfaces including a tear bead area or surface prior to machining of the cavity and tear bead grooves. Such processes selectively harden areas of a mold or mold part without affecting properties of the part as a whole. The electro-hardening of such embodiments results in a treated, rough surface. To subsequently smoothen the surface and to promote flow of air and injection material, a tear bead surface is treated with one or more polymer coatings after machining. Various processes of the present invention increase wear resistance and expand service life of treated parts to varying degrees depending on the surface and the probe materials. A working principal of electro-hardening is based on spontaneous electrical discharges as a vibrating probe touches a surface to be treated. Various embodiments of the present invention contemplate the use of electro-hardening methods to deposit a coating thickness on a mold surface from between approximately 0.2 and 0.8 mils (thousandths of an inch), with between approximately 0.5 and approximately 3.0 mils impregnated under the surface material.

By way of example, one commercially available device that is suitable for electro-hardening operations is the ENDO UR-121 electro metal surface hardening device provided by Rus Sonic Technology, Inc.

In certain embodiments, a method and system is provided wherein one or more tungsten carbide layers are applied to a surface, such as a metallic surface of a mold cavity. In one embodiment, a tungsten carbide layer of between approximately 10 and 100 μm is applied to a surface without affecting properties of the base material(s). In a preferred embodiment, a tungsten carbide layer of between approximately 30 and 50 μm is applied. In various embodiments, tungsten carbide coating methods are performed with the use of a TUCADUR® 2020 coating unit or a ROCKLINIZER® applicator from Rocklin Manufacturing Co. In such embodiments, a tungsten carbide electrode is attached to a positive pole of a DC circuit, and an electrode in a coating gun is caused to oscillate. A workpiece of metal material is connected to the negative pole. During the short contact pulse between the workpiece and electrode, the electrode is briefly heated to such an extent that during discharge, hard metal particles of the electrode are entrained and fuse with the metal surface. The result of such methods is that the metal surface is treated or infused with tungsten carbide and the hardness of the final product is altered and preferably increased. Embodiments of the present invention further contemplate machining the treated surface to a desired shape or feature. In various embodiments, the time to treat an area of approximately one square inch (6.5 cm²) is approximately 10 minutes. During such operations, a relatively minor amount of thermal energy is provided to the workpiece. Accordingly, a unique advantage of the present invention is that there is little or no need to allow the piece to cool prior to subsequent machining steps.

The application of cold gas dynamic spray technology as a metal spray coating method is contemplated as comprising the steps of: providing a powdered metal, metal/ceramic blend, or polymer which is accelerated by compressed air through a supersonic nozzle and is sprayed on the surface to be coated. The hardness, porosity, and thickness of deposited coatings can be controlled by adjustments to the air pressure, pre-heater, and nozzle. Surface materials include metal and metal alloys, ceramic and glass, polymers, paper, and net screen and foil.

Traditional thermal spray coating methods (e.g. plasma, electric arc, HVOF) require high temperature of material particles to adhere to a surface. Typically this temperature exceeds the material melting point thereby creating problems inherent in thermal spray. In cold gas dynamic spray—high temperatures are not required. This technology utilizes the surface interaction of particles moving at supersonic velocities between mach 2-3 (required velocity is dependent upon application and gas carrier). Since high temperatures are not required in cold gas dynamic spray, adhesion and porosity are superior to thermal spray. Traditional thermal methods by definition create undesirable chemistry changes and associated stresses along with defect causing-oxidation. Cold gas dynamic spray utilizes supersonic velocity to spray material into or onto a surface that a strong bond is formed without the undesirable side effects inherent in conventional thermal methods. This technology has substantial benefits over traditional coating methods due to low temperatures, low porosity, and superior adhesion.

The attractiveness of the cold gas dynamic spray method is that the application equipment and deposited coatings have no limitations inherent in other thermal coating methods. The coating quality and adhesion are superior without the complexity of detonation or exotic gas deposition methods. Cold gas dynamic spray technology offers flexibility and economy for a wide variety of applications in a multitude of industries.

In one embodiment, a method of forming a mold cavity for injecting molding operations is provided, the method comprising the steps of providing a first material to be formed into a mold cavity, providing an electrode as a positive pole of a circuit, connecting the first material as the negative pole of said circuit, heating the electrode and causing a discharge of a second material from the electrode to the first material wherein said discharge of the second material to said first material provides a third material, the third material comprising a hardness that is greater than a hardness of the first material, and subsequent to said discharge of the second material, machining the third material to a desired shape.

In various embodiments, methods and devices of the present disclosure contemplate treating and/or hardening a mold material. The mold material may include any one or more of known mold materials as will be recognized by one of ordinary skill in the art. Mold materials to be hardened or treated in accordance with embodiments of the present disclosure include, but are not limited to, tool steels, beryllium-copper, water-hardened steel, cold-worked steel, shock-resistant steel, high-speed steel, hot-worked steel, special purpose steel, aluminum, nickel, and various aluminum alloys (7075 and 2024 alloys, for example).

U.S. Pat. No. 4,675,488 to Mucha et al., which is hereby incorporated by reference in its entirety, provides a method of hardening the surfaces of gears. Mucha et al. provide methods for hardening radially-extending gear surfaces by providing first and second induction heating coils larger than an outer circumference formed by the gear teeth. Mucha et al. contemplate providing power to the coils to inductively heat gear features in two stages, and subsequently quenching the gear features using fluid flow to complete the hardening process. Mucha et al. fail to disclose, however, various novel features and methods of the present disclosure including, for example, selective electro-hardening of certain portions of a material to infuse the material with a second material or element, and achieve hardening without the need to rapidly quench or cool the work piece.

In one embodiment, a method of forming a mold cavity for use in injection molding operations is provided, the method comprising the steps of: providing a first material to be formed into a mold cavity; hardening a first portion of a surface of the first material to provide at least one of a treated, hardened and a roughened surface, wherein the hardening step comprises connecting the first portion of the first material as a negative pole of a circuit, and discharging a second material from a positive pole of the circuit to the first portion of the surface; subsequent to the hardening step, performing a smoothing step of the first portion of the surface, the smoothing step comprising at least one of: applying a polymer coating to the surface, and polishing the surface; machining the first portion of the first material to provide at least one of a cavity and a groove having a desired shape; wherein the hardening step comprises impregnating the first material with the second material to a depth that is less than a depth of the at least one of a cavity and a groove, such that the hardening comprises a surface treatment; and wherein during the hardening step, a relatively minor amount of thermal energy is transferred to the first material and wherein the method is devoid of a cooling step provided between the hardening step and the machining step.

In another embodiment, a method of forming a mold cavity for use in injection molding operations is provided, the method comprising the steps of: providing a first material; providing an electro-hardening device; hardening at least a portion of a surface of the first material, wherein the hardening step comprises connecting the first portion of the first material as a negative pole of a circuit, and discharging a second material from the electro-hardening device, the electro-hardening device comprising a positive pole of the circuit to the first material; subsequent to the hardening step, performing a smoothing step of the first material, the smoothing step comprising at least one of: applying a polymer coating to the surface, and polishing the surface; machining the first material to provide at least one of a cavity and a groove having a desired shape in the first material; wherein the hardening step comprises impregnating the first material with the second material to increase the hardness of the first material; wherein during the hardening step, a relatively minor amount of thermal energy is transferred to the first material such that the first material may be machined without quenching or cooling being performed after the hardening step.

In yet another embodiment, a method of forming a mold cavity for injecting molding operations is provided, the method comprising the steps of: providing a first material to be formed into a mold cavity; providing an electrode as a positive pole of a circuit; connecting the first material as the negative pole of said circuit; heating the electrode and causing a discharge of a second material from the electrode to the first material wherein said discharge of the second material to said first material provides a third material, the third material comprising a hardness that is greater than a hardness of the first material; and subsequent to said discharge of the second material, machining the third material to a desired shape.

In preferred embodiments, a method of forming a mold is provided, the method including a specific sequence and order of operations. In one preferred embodiment, a surface or mold material is milled or prepared to form a working surface. Subsequent to the milling or preparation step, a hardening step is performed. This hardening step preferably comprises an electro-hardening operation to impregnate the first material with hardening elements (e.g. tungsten-carbide). Subsequent to this hardening step, mold features including but not limited to a tear bead are machined into the surface wherein at least a portion of the area that is machined has previously been hardened. Finally, at least a portion of the machined surface is coated or treated to finish and/or smoothen the surface.

In various embodiments, methods and systems of glass encapsulation molds are provided wherein the molds comprise increased hardness and wear properties. In preferred embodiments, methods and systems for glass encapsulation molds are provided wherein the molds comprise a relatively large surface area or volume and wherein a relatively small portion or area of the mold is treated with electro-hardening operations to increase the hardness and wear resistance of specific features of the mold. As electro-hardening operations are known to be generally time-intensive procedures, embodiments of the present invention contemplate conducting such operations only on specific areas or portions of the mold and preferably at locations adjacent to, proximal to, and/or comprising a tear bead structure. Methods and devices of the present invention contemplate electro-hardening the area of the mold comprising and/or being adjacent to a tear bead of a mold that further comprises features for receiving a glass panel and for injecting molding a rubber in combination with the glass panel. In certain embodiments, the tear bead and hardened area comprise an outer perimeter of a mold cavity. The present disclosure thus provides unique systems and methods for hardening only select, specific portions of a mold without the need or cost of hardening or treating an entire mold cavity. An interior portion of the mold, such as a glass saddle, for example, may be devoid of hardening treatment. The present disclosure provides methods ands systems for providing mold cavities with varying hardness, and wherein areas of the mold including or proximal to tear beads or flash areas comprise a greater hardness than a remainder of the mold or mold cavity. Methods of the present disclosure contemplate forming a glass encapsulation mold assembly including the steps of hardening or electro-hardening a specific portion of the mold assembly that is known or anticipated to experience increased wear or usage. Subsequent to a hardening operation, which is preferably performed on a flat or substantially flat surface, the desired mold features are machined into the mold material. The mold material may then be finished or coated as desired to form and provide a mold assembly in accordance with the present disclosure and wherein certain portions of the mold assembly comprise areas of enhanced hardness by the provision of additives or treatments and preferably by electro-hardening techniques.

In various embodiments, a mold cavity device is provided. In certain embodiments, a mold cavity device is provided, the mold cavity comprising a first material and a hardened portion. The hardened portion of the first material comprises a predetermined area of the first material that has been impregnated with a second material using an electro-hardening device, and further comprises a coating or finish. The hardened portion of the first material further comprises at least one mold feature, the at least one mold feature comprising at least one of a recess, a landing, a tear bead, and a mold parting line.

### BRIEF DESCRIPTION OF THE DRAWINGS

The drawings constitute a part of this specification and include exemplary embodiments of the present invention and illustrate various objects and features thereof.

FIG. 1 is a top plan view of a material in accordance with one embodiment of the present invention.

FIG. 2 is a cross-sectional elevation view of a material in accordance with one embodiment of the present invention.

FIG. 3 is a cross-sectional elevation view of a material in accordance with one embodiment of the present invention.

FIG. 4 is a flow-chart depicting a process according to one embodiment of the present invention.

### DETAILED DESCRIPTION OF THE INVENTION

It is to be understood that while certain forms of the present invention have been illustrated and described herein, it is not to be limited to the specific forms or arrangement of parts described and shown.

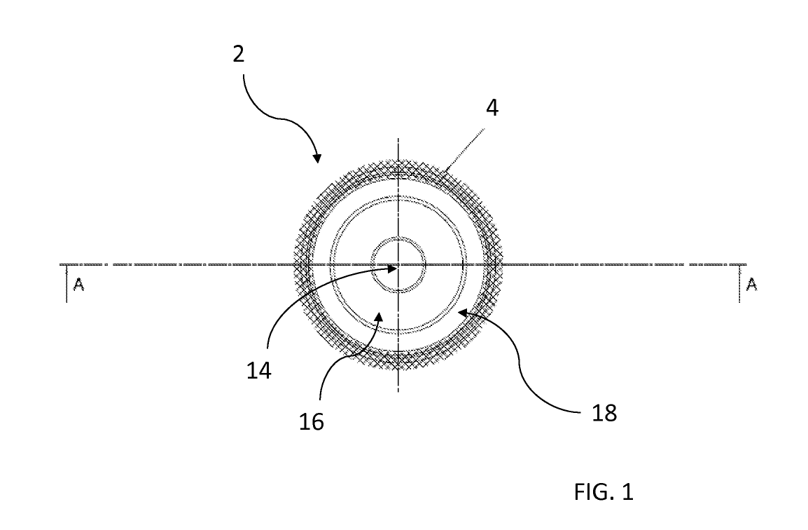

As shown in FIG. 1, a top plan view of a material for treatment and forming into a mold is provided. The material 2 comprises an electro-hardened area prior to final machining and shaping of the desired product. In various embodiments, the desired product or final shape comprises a mold cavity with a cavity surface and a tear bead as shown and described herein. A central area 14 is provided radially inward from a cavity surface 16. In certain embodiments, the cavity surface 16 comprises a downwardly extending ramp surface 18 which terminates at the area 4 to be electro-hardened and ultimately formed into a tear bead feature. Although FIG. 1 depicts a material to be formed as a mold cavity surface in a substantially circular and concentric feature, it will be expressly recognized that the present invention is not so limited. Indeed, methods and systems of the present invention may be provided in any number of sized or shaped devices and materials.

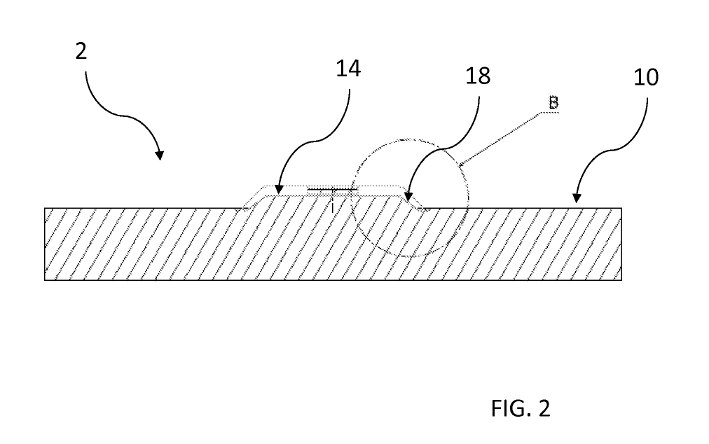

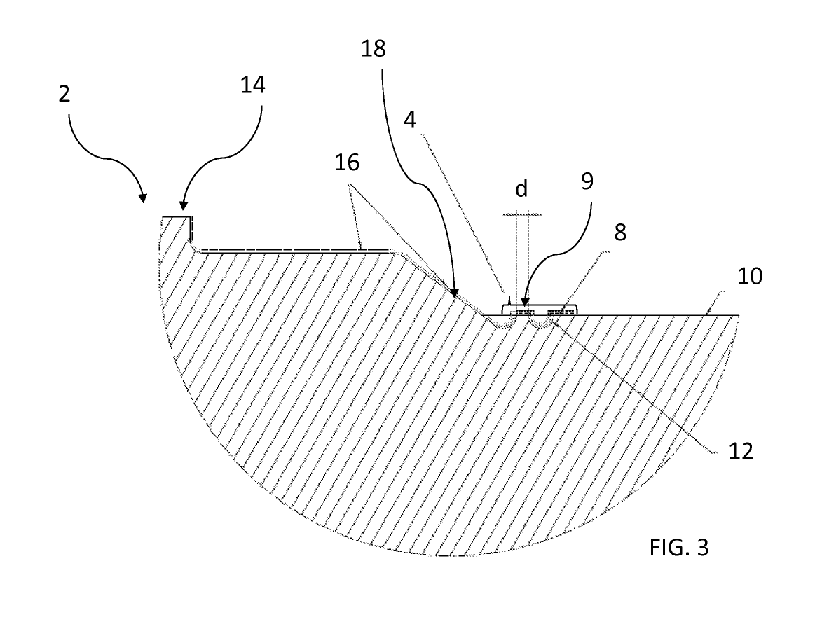

FIG. 2 is a cross-sectional elevation view taken above line A-A of FIG. 1. As shown, a mold material 2 comprises a central area 14, a ramp surface 18, and a parting line 10, the parting line 10 provided external to an area 4 of electro-hardening. The ramp feature 18 comprises a ramp extending downwardly from the central area 14 to a hardened area 4 including a landing area 9 and coated area 8 as shown in FIG. 3.

FIG. 3 is a detailed cross-sectional view of detail area B of FIG. 2. As shown, a mold material 2 is provided. A central area 14 is provided adjacent a cavity surface 16 which includes a ramped portion 18. An area of electro-hardening 4 is provided which includes a landing area 9 comprising a distance d, a tear bead 12, and an area of polymer coating 8. A parting line 10 is provided radially outside of the area 4. As shown, the tear bead 12 comprises a channel or recess in the mold material 2 along a perimeter of a mold cavity 16, the mold cavity 16 comprises a cavity in which a part is molded or formed. Accordingly, in the depicted embodiment, the mold cavity 16 is adapted to receive and form material in a conical, semi-conical, or frustoconical shape. It will be recognized, however, that the present disclosure is not limited to a mold cavity with any particular size or shape and that methods and devices of the present disclosure contemplate and include any number, sizes, and shapes of mold cavities as may he desired for the injection-mold formation of various parts and devices.

The groove or grooves of the tear bead 12 generally have two functions. First, grooves allow trapped air to escape the cavity 16 and thereby allow for the molded part to fully conform to and take the shape of the cavity 16. Grooves further allow for excess injection material to spill or overflow out of the mold area 16. After a molded part is formed, an operator may remove excess or spilled material from the molded part by tearing the excess material along groove or bead 12. In various embodiments of the present invention, methods of forming the mold material 2 are provided wherein at least a portion of the mold material is subjected to an electro-hardening operation. As shown in FIG. 3, an area that includes at least a portion of the tear bead 12 is subjected to an electro-hardening operation, which may include an infusion of tungsten carbide prior to machining or forming the final shape of the mold cavity 16 and/or tear head 12.

As shown in FIG. 3, a first material is formed into a mold feature comprising a central area 14 surrounded by a mold cavity 16, the mold cavity 16 comprising a planar portion and a ramped portion 18. The mold cavity 16 is surrounded by a landing area 9 with a width d, the width d separates the cavity 16 from a tear bead 12, the tear bead extending circumferentially around at least a portion of the mold cavity 16. An area at least partially covering the outer portion of the tear bead 12 is provided with a coating 8, and a parting line 10 extends radially outwardly from the tear bead 12.

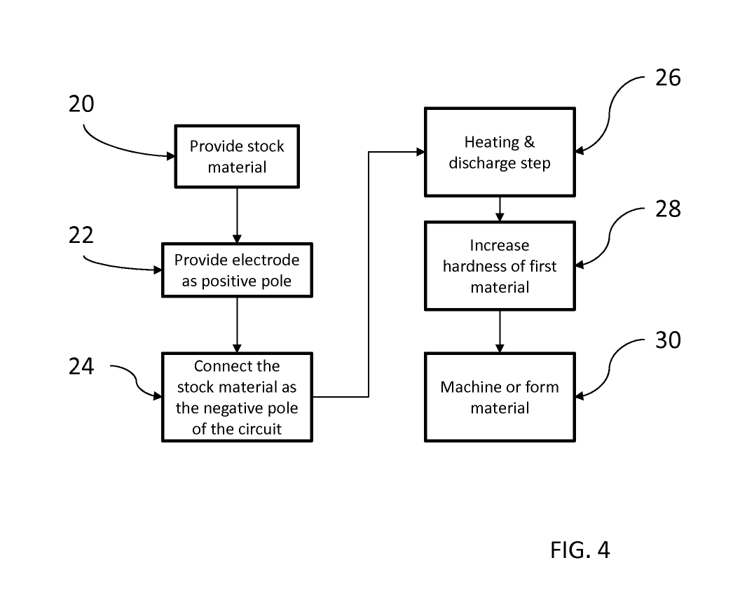

FIG. 4 is a flowchart of a process according to one embodiment of the present invention wherein a mold surface is formed or prepared. As shown, at step 20 a stock material, such a mold steel, is provided. At step 22, an electrode is provided wherein the electrode comprises the positive pole of a circuit. At step 24, the circuit is connected by providing the stock material as the negative pole of the circuit such that current and/or material may flow from the electrode to the stock material. At step 26, the electrode is heated by providing current to the electrode and a discharge is caused wherein a second material is discharged or injected into the first material. This discharge or combination of the second material with the first material may be considered as forming a third material, the third material comprising an alloy or combination of the first material and the second material. By infusing the second material, and as shown in step 28, the hardness of the resultant material is provided as being of a higher hardness than the first stock material. Subsequent to this hardening, and as shown in step 30, the resultant material is machined or formed to the desired shape. The desired shape, as will he recognized by one of ordinary skill in the art is any shape that is desired within the mold cavity. This shape includes, but is not limited to a tear bead feature as shown and described herein.

By performing steps as shown and described herein, such as hardening a material as provided and prior to machining the mold surface, unexpected results have been obtained. In embodiments of the present invention comprising a method of forming a mold cavity, surfaces hardnesses in excess of 80 Rockwell have been realized. Such embodiments provide distinct and unexpected advantages over known nitrating or steel hardening processes wherein maximum hardness values are approximately 60 Rockwell.

What is claimed is:

1. A method of forming a mold cavity for use in injection molding operations, the method comprising the steps of:
providing a first material to be formed to comprise a mold cavity;
hardening a first portion of a surface of the first material to provide at least one of a treated, hardened and a roughened surface, wherein the hardening comprises connecting the first portion of the first material as a negative pole of a circuit, and discharging a second material from a positive pole of the circuit to the first portion of the surface;
subsequent to the hardening step, machining the first portion of the first material to provide at least one of a cavity and a groove having a desired shape;
wherein the hardening step comprises impregnating the first material with the second material to a depth that is less than a depth of the at least one of a cavity and a groove;
subsequent to the machining step, performing a smoothing step of the first portion of the surface, the smoothing step comprising at least one of: applying a polymer coating to the surface, and polishing the surface;
wherein during the hardening step, a relatively minor amount of thermal energy is transferred to the first material and wherein the method is devoid of a cooling step provided between the hardening step and the machining step.

2. The method of claim 1, wherein the hardening step comprises impregnating the first material with the second material to a depth of between approximately 0.0005 inches and approximately 0.003 inches into the first material.

3. The method of claim 1, wherein the hardening step comprises impregnating the first material with a second material comprising tungsten carbide.

4. The method of claim 3, wherein a layer of tungsten carbide of between approximately 10 μm and 100 μm is applied to the surface of the first material.

5. The method of claim 3, wherein a layer of tungsten carbide of between approximately 30 μm and 50 μm is applied to the surface of the first material.

6. The method of claim 1, wherein the first portion of the first material includes an area of the first material to be formed into a landing area and a tear bead of the finished mold.

7. The method of claim 1, wherein the first material comprises a mold steel.

8. A method of forming a mold cavity for use in injection molding operations, the method comprising the steps of:
providing a first material;
providing an electro-hardening device;
hardening at least a portion of a surface of the first material, wherein the hardening step comprises connecting the first portion of the first material as a negative pole of a circuit, and discharging a second material from the electro-hardening device into the first material, the electro-hardening device comprising a positive pole of the circuit;
subsequent to the hardening step, performing a smoothing step, the smoothing step comprising at least one of: applying a polymer coating to the surface, and polishing the surface;
machining the surface to provide at least one of a cavity and a groove having a desired shape;
wherein the hardening step comprises impregnating the first material with the second material to increase the hardness of the first material;
wherein during the hardening step, a relatively minor amount of thermal energy is transferred to the first material such that the first material may be machined without quenching or cooling being performed after the hardening step.

9. The method of claim 8, wherein the hardening step comprises impregnating the first material with the second material to a depth of between approximately 0.0005 inches and approximately 0.003 inches.

10. The method of claim 8, wherein the hardening step comprises impregnating the first material with a second material comprising tungsten carbide.

11. The method of claim 10, wherein a layer of tungsten carbide of between approximately 10 μm and 100 μm is applied to the surface of the first material.

12. The method of claim 10, wherein a layer of tungsten carbide of between approximately 30 μm and 50 μm is applied to the surface of the first material.

13. The method of claim 8, wherein the first material includes an area to be formed into at least one of a landing area and a tear bead of the finished mold.

14. The method of claim 8, wherein the first material comprises a mold steel.

15. A method of forming a mold cavity for injecting molding operations, the method comprising the steps of:
providing a first material to be formed into a mold cavity;
providing an electrode as a positive pole of a circuit;
connecting the first material as the negative pole of said circuit;
heating the electrode and causing a discharge of a second material from the electrode to the first material wherein said discharge of the second material to said first material provides a third material, the third material comprising a hardness that is greater than a hardness of the first material; and
subsequent to said discharge of the second material, machining the third material to a desired shape.

16. The method of claim 15, wherein the second material comprises tungsten carbide.

17. The method of claim 15, wherein the discharge step comprising applying a layer of the second material having a depth that is at least approximately 10 μm.

18. The method of claim 15, wherein the desired shape comprises a tear bead of a mold cavity.

19. The method of claim 15, wherein the second material comprises tungsten carbide.

20. The method of claim 15, wherein the first material comprises a mold steel.
